(19) United States
(12) Patent Application Publication
(10) Pub. No.: US 2013/0165101 A1
(43) Pub. Date: Jun. 27, 2013

(54) METHOD FOR FEATURE ACTIVATION OF MACHINE TYPE COMMUNICATION AND MTC DEVICE THEREOF

(71) Applicants: Feng Han, PuDong Jinqiao Shanghai (CN); Wu Zheng, PuDong Jinqiao Shanghai (CN); Kaibin Zhang, PuDong Jinqiao Shanghai (CN); Qun Zhao, PuDong Jinqiao Shanghai (CN)

(72) Inventors: Feng Han, PuDong Jinqiao Shanghai (CN); Wu Zheng, PuDong Jinqiao Shanghai (CN); Kaibin Zhang, PuDong Jinqiao Shanghai (CN); Qun Zhao, PuDong Jinqiao Shanghai (CN)

(73) Assignee: ALCATEL LUCENT, Paris (FR)

(21) Appl. No.: 13/819,509

(22) PCT Filed: Aug. 24, 2011
(86) PCT No.: PCT/IB11/02295

§ 371 Date: Feb. 27, 2013

(30) Foreign Application Priority Data
Aug. 27, 2010 (CN) 201010267418.0

(51) Int. Cl. H04W 52/02

(52) U.S. Cl. CPC H04W 52/0251
USPC 455/418

(57) ABSTRACT

The present disclosure provides a novel method for feature activation in the Machine Type Communication and a device thereof. According to the present disclosure, the MTC device may actively trigger entry into or exit from a feature state of the MTC device, and inform the network to perform suitable configuration, so as to meet the requirements of the MTC scenario and optimize the network performance. Furthermore, for the Extra Low Power Consumption feature, it is also proposed to set a MTC device specific DRX cycle as its actual cycle such that the actual cycle may be not limited by the system default DRX configuration information. Therefore, power consumption for the MTC device in the Extra Low Power Consumption state may be reduced.

### FIELD OF THE INVENTION

The present disclosure relates to Machine Type Communication (MTC) technology, and more particularly to feature activation in Machine Type Communication and an MTC device thereof.

### BACKGROUND

Machine Type Communication (MTC) is a form of data communication which does not necessarily need human interactions. MTC has been identified as one efficient way to provide various practical applications, such as smart metering, road safety, etc. A basic communication scenario for MTC is illustrated in FIG. 1, where an MTC device communicates with an MTC server or an MTC User Equipment (MTC UE) via an operating network. To facilitate MTC, currently in 3GPP, more than fifteen features have been defined, such as Low Mobility, Extra Low Power Consumption, Priority Alarm, etc. The Extra Low Power Consumption feature is applicable for MTC devices that are powered by batteries but may not be charged anywhere and anytime, and especially applicable for gas metering MTC devices.

Currently, features of a MTC device are subscribed in a subscriber database of a core network entity such as a Home Location Register (HLR) or a Home Subscriber Server (HSS). A user may activate or deactivate features of the MTC device by defined interfaces or Web interfaces. Therefore, feature activation and deactivation for the MTC device are triggered by the UE, instead of the MTC device itself. Such a procedure for feature activation and deactivation is relatively static and features will remain in an activated or deactivated state over time unless the user changes its status. However, there are many scenarios where an MTC device is required to actively trigger entry or exit of a certain feature state of the MTC device and to inform the network for suitable configuration. However, currently there are still no solutions for this problem.

For the Extra Low Power Consumption feature in the MTC, there are many scenarios where an MTC device is required to move frequently and has to be charged in specific areas. That is to say, in some areas, the Extra Low Power Consumption feature is not necessary, while in other areas, it becomes necessary. For example, an MTC device used for tracking old people or children may be charged anytime when at home, while in the worst scenario, such as when the old people or the children are missing, the MTC device is required to enter into an Extra Low Power Consumption state so as to work longer. Therefore, as indicated in the Document [1] listed below, the MTC device should actively trigger entry or exit of the Extra Low Power Consumption state and inform the network for performance optimization. However, there are still no solutions for this problem.

As another example, an MTC device used for medical sensing will transmit only a small amount of data to the user of the MTC device periodically in general scenarios, however, if an emergent event occurs, the Priority Alarm feature may be activated, and the MTC device may transmit an emergent alarm message to the network as well as a large amount of detected medical data. Therefore, the MTC device needs to actively inform the network of activation or deactivation of its Priority Alarm feature.

In addition to the activation or deactivation of Extra Low Power Consumption feature and Priority Alarm feature as discussed above, there are also many scenarios where the MTC device needs to dynamically trigger various other features and inform the network.

Furthermore, for the Extra Low Power Consumption of MTC, a UE in an idle state may reduce power consumption by means of Discontinuous Reception (DRX) mechanism, which is especially important for MTC devices with the Extra Low Power Consumption feature. To extend the serving life of an MTC device with the Extra Low Power Consumption feature, the DRX cycle should be configured to be far longer than the system default cycle. The UE only needs to monitor the control channel at certain subframes, and may turn off its receiver at other subframes so as to save power consumption. The Document indicates that the actual DRX cycle depends on the smaller value of a UE specific DRX cycle and the system default DRX cycle, wherein the former is configured by the administrator of the user, while the latter is broadcast by the system. In current standards, the system default cycle value may be 32, 64, 128 and 256 radio frames. To support the Extra Low Power Consumption feature, the MTC device specific DRX cycle will be configured to be a very large value, such as 1024 radio frames. Assuming that the system default DRX cycle is 256 radio frames, the actual DRX cycle for the MTC device will be of a value of 256, which departs from the initial system design concept. In this regard, for an MTC device with the Extra Low Power Consumption feature, the DRX cycle thereof is limited by the system default cycle, and thus a new mechanism is needed to save power.

A possible solution is to define a system default DRX cycle specific for the MTC device with the Extra Low Power Consumption feature. According to an example in the LTE system, the LTE system may perform a system configuration through a PCCH-config (Paging Control Channel) where a system default DRX cycle suitable for the MTC device is newly defined. When the MTC device activates its Extra Low Power Consumption feature, it will compare values of the newly defined system default DRX cycle and the UE specific DRX cycle, and take the smaller value to be the DRX cycle. However, this method is not beneficial because it will introduce new signaling in the system broadcast messages and thus signaling overhead will be increased. In the meanwhile, if the current DRX mechanism is used, the DRX cycle may not be properly configured, which departs from the initial system design concept.

In view of the above, it is necessary to design an efficient mechanism for the Extra Low Power Consumption feature, which is also one of the problems to be resolved by the present disclosure.
[1] 3GPP TS 22.368 V1.1.1 Service requirements for machine-type communications, stage 1
[2] 3GPP TS 36.304 User Equipment (UE) procedures in idle mode

### SUMMARY

To overcome the above disadvantages in the prior art, the present disclosure provides a novel method for feature activation in MTC and an MTC device thereof. According to the present disclosure, the MTC device may actively trigger entry into or exit from a certain feature state of the MTC device and inform a network to perform a suitable configuration so as to meet the requirement of the MTC scenario and optimize the network performance. Furthermore, for the Extra Low Power Consumption feature, it is also proposed to set an MTC device specific DRX cycle as its actual cycle such that the actual cycle may not be limited by the system default DRX configuration information. Therefore, power consumption for the MTC device in the Extra Low Power Consumption state may be reduced.

In particular, according to an embodiment of the present invention, a method for feature activation for Machine Type Communication MTC is provided, including:
transmitting, by an MTC device, a feature activation request for a feature to a Mobility Management Entity MME;
checking, by the MME, whether the MTC device has subscribed to the feature;
if the MTC device has subscribed to the feature, permitting, by the MME, the feature activation request, and transmitting, by the MME, a feature state updating request to a core network entity to update feature state of the MTC device;
transmitting, by the core network entity, a feature state updating response to the MME;
transmitting, by the MME, a state change message to a Base Station (BS);
performing, by the BS, radio access network optimization, then the MTC device entering into a feature activated state; and
if the MTC device has not subscribed to the feature, transmitting, by the MME, a response message indicating refusal of the activation request, and the MTC device remaining in a feature deactivated state.

According to an alternative embodiment of the present invention, if the MTC device has not subscribed to the feature, a subscription request is transmitted from the MME to the core network entity that inquires a MTC server about whether to perform a feature subscription.

According to an alternative embodiment of the present invention, transmitting, by an MTC device, a feature activation request for a feature to an MME includes transmitting, by the MTC device, the feature activation request to the BS by using non-access layer signaling, the feature activation request being then transmitted by the BS to the MME.

According to an alternative embodiment of the present invention, transmitting, by an MTC device, a feature activation request for a feature to an MME includes transmitting, by the MTC device, the feature activation request to the BS by using a Radio Resource Control (RRC) message, the feature activation request being then transmitted by the BS to the MME.

According to an alternative embodiment of the present invention, transmitting, by an MTC device, a feature activation request for a feature to an MME includes transmitting a predefined parameter to the MME.

According to an alternative embodiment of the present invention, the feature includes an Extra Low Power Consumption feature, the feature state includes an Extra Low Power Consumption feature state, and the radio access network optimization includes Radio Resource Control (RRC) connection reconfiguration.

According to an alternative embodiment of the present invention, the feature includes a Priority Alarm feature, and the feature state includes a Priority Alarm feature state.

According to an alternative embodiment of the present invention, the feature includes an Extra Low Power Consumption feature, the feature state includes an Extra Low Power Consumption feature state, the MTC device operates in a Discontinuous Reception (DRX) state when the feature state is the Extra Low Power Consumption feature state, and the predefined parameter is a predefined UE specific DRX cycle.

According to an alternative embodiment of the present invention, after the radio access network optimization, the MTC device operates in a Discontinuous Reception (DRX) state when the feature state is the Extra Low Power Consumption feature state, and the DRX cycle is a UE specific DRX cycle.

According to an embodiment of the present invention, a method for feature deactivation for Machine Type Communication MTC is provided, including:
transmitting, by a MTC device, a feature deactivation request for a feature to a Mobility Management Entity (MME);
permitting, by the MME, the feature deactivation request, and transmitting, by the MME, a feature state updating request to a core network entity to update feature state of the MTC device;
transmitting, by the core network entity, a feature state updating response to the MME;
transmitting, by the MME, a state change message to a Base Station (BS); and
performing, by the BS, radio access network optimization, then the MTC device entering a feature deactivated state.

According to an alternative embodiment of the present invention, transmitting, by a MTC device, a feature deactivation request for a feature to an MME includes transmitting, by the MTC device, the feature deactivation request to the BS by using non-access layer signaling, the feature deactivation request being then transmitted by the BS to the MME.

According to an alternative embodiment of the present invention, transmitting, by an MTC device, a feature deactivation request for a feature to an MME includes transmitting, by the MTC device, the feature deactivation request to the BS by using a Radio Resource Control (RRC) message, the feature deactivation request being then transmitted by the BS to the MME.

According to an alternative embodiment of the present invention, transmitting, by an MTC device, a deactivation request for a feature to an MME includes transmitting a predefined parameter to the MME.

According to an alternative embodiment of the present invention, the feature includes an Extra Low Power Consumption feature, the feature state includes an Extra Low Power Consumption feature state, and the radio access network optimization includes Radio Resource Control (RRC) connection reconfiguration.

According to an alternative embodiment of the present invention, the feature includes a Priority Alarm feature, and the feature state includes a Priority Alarm feature state.

According to an alternative embodiment of the present invention, the feature includes an Extra Low Power Consumption feature, the feature state includes an Extra Low Power Consumption feature state, the MTC device operates in a Discontinuous Reception (DRX) state when it exits the Extra Low Power Consumption feature state, and the predefined parameter is the smaller value of a predefined UE specific DRX cycle and a system default cycle.

According to an alternative embodiment of the present invention, after the radio access network optimization, the MTC device operates in a Discontinuous Reception (DRX) state when the feature state is the Extra Low Power Consumption feature state, and DRX cycle is the smaller value of a UE specific DRX cycle and a system default cycle.

According to an embodiment of the present invention, a Machine Type Communication MTC device is provided, including:
first transmitting means configured to transmit a feature activation request;
second transmitting means configured to transmit a feature deactivation request;
receiving means configured to receive a feature configuration message;
feature activation means configured to activate a feature such that the MTC device operates in a feature activated state when the received feature configuration message indicates permission of feature activation; otherwise, to keep the MTC device in a feature deactivated state when the received feature configuration message indicates refusal of feature activation; and
feature deactivation means configured to deactivate a feature such that the MTC device operates in a feature deactivated state when the received feature configuration message indicates permission of feature deactivation; otherwise, to keep the MTC device in a feature activated state when the received feature configuration message indicates refusal of feature deactivation.

According to an alternative embodiment of the present invention, in the MTC device, the first transmitting means is configured to transmit an Extra Low Power Consumption feature activation request;
the second transmitting means is configured to transmit an Extra Low Power Consumption feature deactivation request;
the receiving means is configured to receive an Extra Low Power Consumption feature configuration message;
the feature activation means is configured to activate an Extra Low Power Consumption feature such that the MTC device operates in an Extra Low Power Consumption feature activated state when the received Extra Low Power Consumption feature configuration message indicates permission of Extra Low Power Consumption feature activation; otherwise, to keep the MTC device in an Extra Low Power Consumption feature deactivated state when the received feature configuration message indicates refusal of Extra Low Power Consumption feature activation; and
the feature deactivation means is configured to deactivate an Extra Low Power Consumption feature such that the MTC device operates in an Extra Low Power Consumption feature deactivated state when the received Extra Low Power Consumption feature configuration message indicates permission of Extra Low Power Consumption feature deactivation; otherwise, to keep the MTC device in an Extra Low Power Consumption feature activated state when the received Extra Low Power Consumption feature configuration message indicates refusal of Extra Low Power Consumption feature deactivation

Further, the MTC device also includes Discontinuous Reception (DRX) cycle setting means configured to set a UE specific DRX cycle as an actual cycle value for the DRX when the MTC device operates in the Extra Low Power Consumption feature activated state, and to set the smaller value of the UE specific DRX cycle and a system default cycle as the actual cycle value for the DRX.

According to an alternative embodiment of the present invention, the first transmitting means is configured to transmit a Priority Alarm feature activation request;
the second transmitting means is configured to transmit a Priority Alarm feature deactivation request;
the receiving means is configured to receive a Priority Alarm feature configuration message;

the feature activation means is configured to activate a Priority Alarm feature such that the MTC device operates in a Priority Alarm feature activated state when the received Priority Alarm feature configuration message indicates permission of Priority Alarm feature activation; otherwise, to keep the MTC device in a Priority Alarm feature deactivated state when the received Priority Alarm feature configuration message indicates refusal of Priority Alarm feature activation; and
the feature deactivation means is configured to deactivate a Priority Alarm feature such that the MTC device operates in a Priority Alarm feature deactivated state when the received Priority Alarm feature configuration message indicates permission of Priority Alarm feature deactivation; otherwise, to keep the MTC device in a Priority Alarm feature activated state when the received Priority Alarm feature configuration message indicates refusal of Priority Alarm feature deactivation.

### BRIEF DESCRIPTION OF THE DRAWING(S)

Other objectives and effects will become more apparent and easily understood after a more thorough understanding of the present invention from the following descriptions taken in connection with the accompanying drawings in which:

FIG. 1 illustrates a basic communication system architecture of MTC.

FIG. 2 illustrates a schematic diagram of the feature activation/deactivation procedure according to an embodiment of the present invention.

FIG. 3 illustrates a flow chart of the DRX mechanism according to an embodiment of the present invention.

FIGS. 4a and 4b illustrate schematic diagrams of the structure of the MTC device according to embodiments of the present invention.

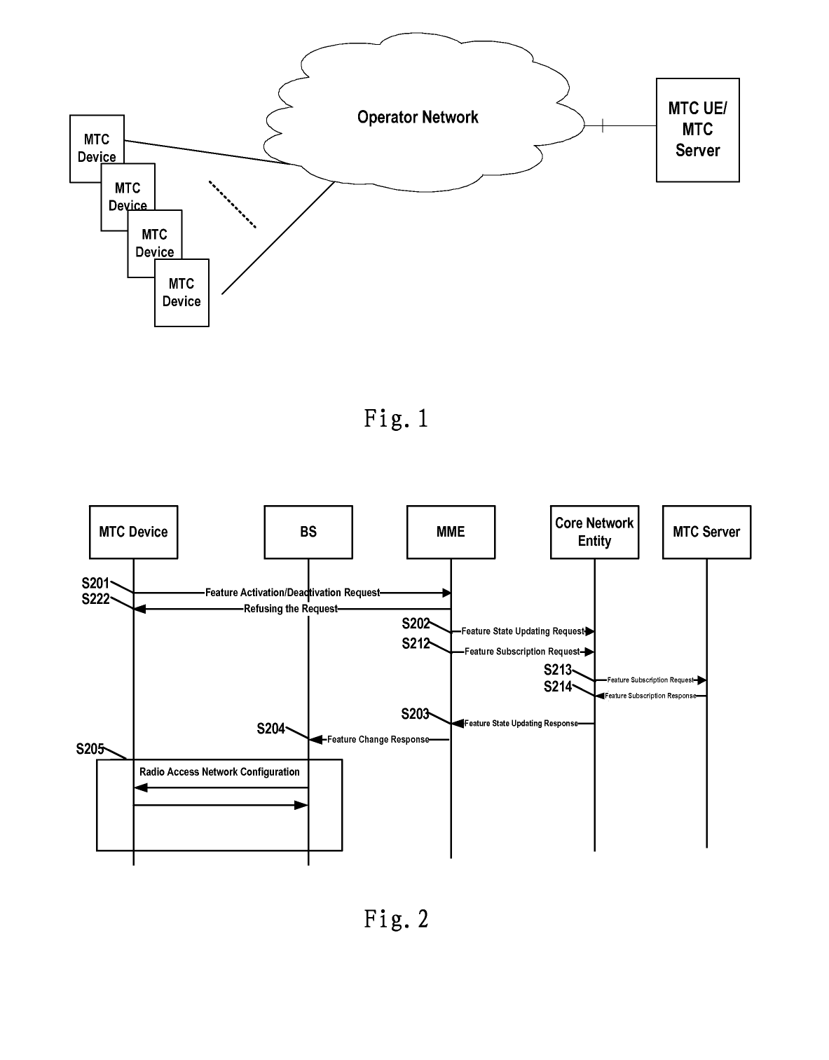

Like numeric references indicate the same, similar or corresponding features or functions throughout all of the above figures.

### DETAILED DESCRIPTION

Hereinafter, various embodiments of the present invention will be described in detail in connection with the accompanying figures.

FIG. 2 illustrates a schematic diagram of the feature activation/deactivation procedure according to an embodiment of the present invention, which is applicable in a 3GPP network where an MTC device actively initiates feature activation or feature deactivation. In an embodiment for initiating a request for feature activation, in step S201, the MTC device initiates a feature activation request to a Mobile Management Entity (MME), which in turn determines whether to permit the feature activation request.

If the list of features subscribed by the MTC device includes features that are requested to be activated, the procedure proceeds to step S202 where the MME permits the feature activation request and transmits a feature state updating request to a core network entity. At step S203, the core network entity returns a feature state updating response to the MME. At step S204, the MME transmits the feature state updating response to a base station (BS). Subsequently, at step S205, the radio access network is configured. For example, the BS performs Radio Resource Control (RRC) connection reconfiguration for the MTC device, and the MTC device transmits a RRC connection reconfiguration complete message. After the configuration of the radio access network, the MTC device enters into a feature activated state.

If the list of features subscribed by the MTC device does not include features that are requested to be activated, the MME may refuse the feature activation request, and then step S222 is performed, where the MME transmits a response of refusing the feature activation request.

Alternatively, if the list of features subscribed by the MTC device does not include features that are requested to be activated, at step S212, the MME may transmit a feature subscription request to the core network entity. At step S213, the core network entity transmits the feature subscription request to the MTC server. At step S214, the MTC server returns a feature subscription response to the core network entity.

The embodiment for a feature deactivation procedure is similar to the above, and thus is not described in detail here.

There are various manners for the MTC device to initiate feature activation/deactivation request to the MME at step S201 such as those described below.

### Implicit Method

In this method, rules should be predefined between the MTC device and the network. The MTC device indicates its state change to the network in the implicit method. Based on the predefined rules between the MTC device and the network, the network may identify the state change of the MTC device. Specifically, when the MTC device enters into or exits from a feature state, it triggers a feature activation/deactivation request message including UE specific parameters. The network may identify the state of the MTC device according to a predefined UE specific parameter value. This method just employs predefined rules, and thus may operate with minimum specification efforts.

### Explicit Method 1

In this method, the MTC device transmits an explicit message to the network via a non-access layer signaling to indicate its state change. This function may be implemented by defining a new non-access layer signaling or extending the current signaling.

### Explicit Method 2

In this method, Radio Resource Control (RRC) messages are used. This method may extend the conventional RRC messages such as a measurement report message, or define a new RRC message. If the BS receives such a message, it will transfer the message to the MME.

Hereinafter, taking the Extra Low Power Consumption feature as an example, a detailed description is given as follows.

Since the conventional DRX can not meet the requirement of Extra Low Power Consumption feature, the present invention proposes a solution in which the MTC device in the Extra Low Power Consumption state only utilizes a UE specific DRX cycle value. In particular, when the MTC device enters into the Extra Low Power Consumption state, it will use the UE specific DRX cycle value as its actual cycle value, instead of the system default cycle. On the other hand, when the MTC device exits from the Extra Low Power Consumption state, it turns back to the conventional DRX mechanism, i.e., using a cycle value depending on the smaller value of the UE specific cycle value and the system default cycle value.

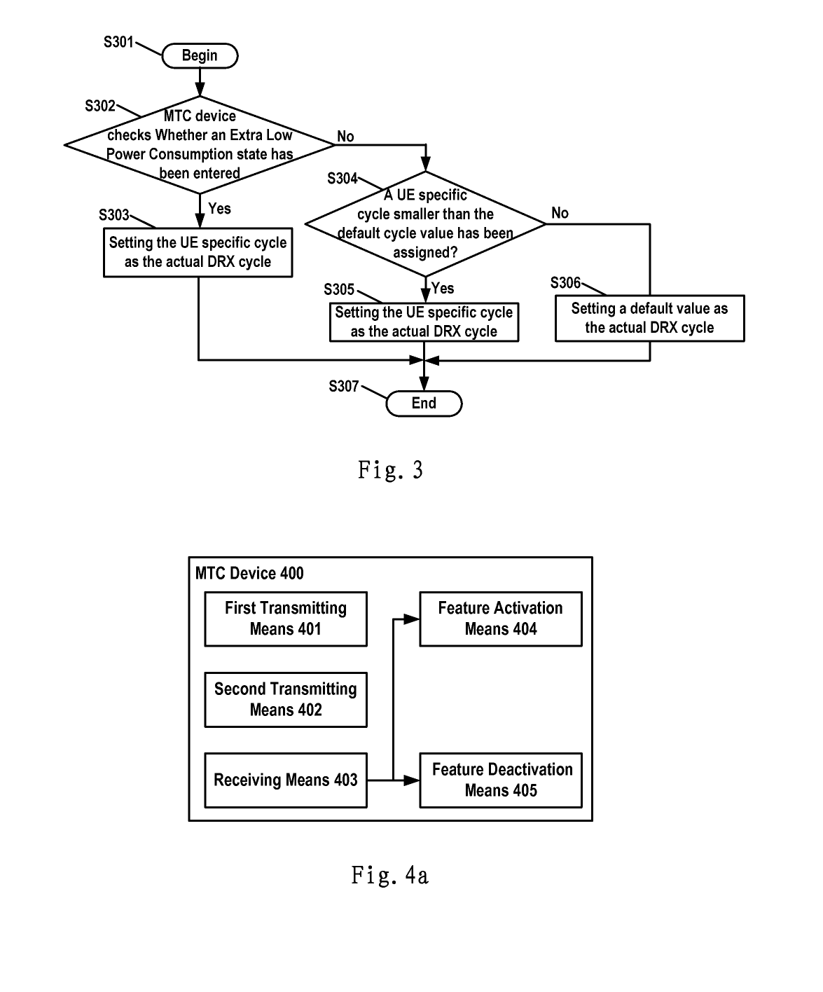

FIG. 3 illustrates the DRX mechanism according to an embodiment of the present invention.

The procedure begins with steps S301. At step S302, the MTC device checks whether an Extra Low Power Consumption state has been entered into. If YES, the procedure proceeds to step S303 where the UE specific cycle is set as the actual DRX cycle value, and then the procedure ends at step S307. If NO, the procedure proceeds to step S304 where it is determined whether a UE specific cycle smaller than the default cycle value has been assigned. If the UE specific cycle smaller than the default cycle value has been assigned, the procedure proceeds to step S305 where the UE specific cycle is set as the actual DRX cycle value, and then the procedure ends at step S307. If the UE specific cycle smaller than the default cycle value has not been assigned, the procedure will proceed to step S306 where the default value is set as the actual DRX cycle value, and then the procedure ends at step S307.

Based on the procedure of feature activation/deactivation as shown in FIG. 2, the network may identify when the MTC device should activate or deactivate the Extra Low Power Consumption state such that the network may keep DRX in synchronization with the MTC device. In this way, the network and the MTC device may work properly. This mechanism does not have any effect on other UEs or MTC devices in the system, and thus will minimize the specification efforts.

For the implicit method for activating/deactivating of the Extra Low Power Consumption feature, more specifically, once the MTC device enters into or exits from the Extra Low Power Consumption state, it will transmit to the network information including the predefined UE specific DRX parameter, the transmission access request message or the tracking area update (TAU) request message. For example, when the MTC device enters into the Extra Low Power Consumption state, it will transmit to the MME the UE specific DRX parameter such as 512 subframes, with which the MME may identify that the MTC device requests to enter into the Extra Low Power Consumption state. Similarly, when the UE specific DRX parameter is 32 subframes for example, the MME may identify that the MTC device requests for deactivation of the Extra Low Power Consumption state.

In the explicit methods, the MTC device transmits, through a non-access layer signaling, to the network an explicit message indicating that its power state has been changed. This may be implemented by defining a new non-access layer signaling or extending the current signaling. The signaling flowchart is illustrated in FIG. 2, with the detailed procedure specified as follows.

When the MTC device needs to enter into or exit from the Extra Low Power Consumption state, it transmits an explicit non-access layer message to the MME (see step S201).

If the MTC device reports that it has entered into the Extra Low Power Consumption state, the MME determines whether to permit the activation request. If the list of features subscribed by the MTC device includes the requested feature, the MME permits the request and updates the feature state of the MTC device, and the procedure proceeds to step S202. Otherwise, the MME may perform any of the following:
refusing the activation request directly, and indicating the reason of refusal in a response message (see step S222); or
transmitting a subscription request to the core network entity such as the subscriber database (see step S212), the subscriber database then transmitting the subscription request to the MTC server (see step S213).

The MME transmits a feature state updating request to the core network entity such as the subscriber database (see step S222), and the core network entity such as the subscriber database returns a state updating response (see step S203).

The MME transmits a state change message to the BS such that the BS may perform network optimization such as RRC connection reconfiguration, so as to reduce power consumption of the MTC device.

In another explicit method using the RRC message, it extends the conventional RRC message. For example, it may extend the measurement report message or define a new RRC message. The subsequent procedures are very similar to those in the explicit method using a non-access layer message, and thus the detailed description thereof is omitted.

In addition to the activation or deactivation of the Extra Low Power Consumption state as stated above, there are still many scenarios where the MTC device will always dynamically activate various features based on the measurement mechanism or certain events and inform the network. For example, the MTC device used for medical sensing will transmit only a small amount of data to the user of the MTC device periodically in general scenarios; however, if an emergent event occurs, the Priority Alarm feature may be activated, and the MTC device may transmit an emergent alarm message to the network as well as a large amount of detected medical data. Therefore, the MTC device needs to actively inform the network of activation or deactivation of its Priority Alarm feature. It is apparent that the explicit methods for activation or deactivation of the Extra Low Power Consumption feature may also be used for activation or deactivation of other features.

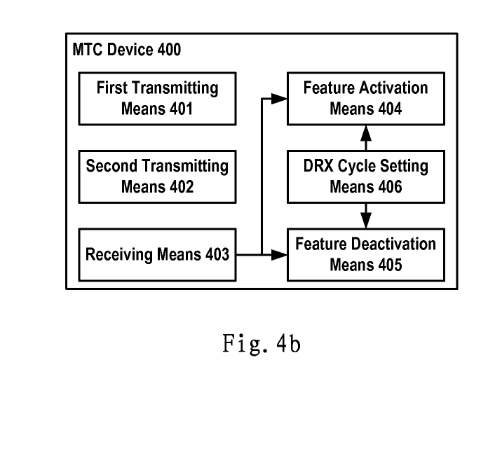

FIG. 4 illustrates schematic diagrams of the structure of the MTC device according to embodiments of the present invention. In FIG. 4a, a schematic diagram of a general MTC device 400 with the feature activation/deactivation function of the present invention is illustrated. The MTC device 400 includes a first transmitting means 401, a second transmitting means 402, a receiving means 403, a feature activation means 404 and a feature deactivation means 405.

In particular, the first transmitting means 401 is configured to transmit a feature activation request. When the MTC device 400 needs to enter into a feature state, the first transmitting means 401 is triggered to transmit the feature activation request. The feature activation request may be transmitted in either the implicit method or the explicit methods, depending on the system design constraint. In the implicit method, rules should be predefined between the MTC device and the network. The MTC device indicates its state change to the network in the implicit method. Based on the predefined rules between the MTC device and the network, the network may clearly identify the state change of the MTC device. Specifically, when the MTC device needs to enter into or exit from a feature state, it triggers a feature activation request message including a UE specific parameter. The network may identify the state of the MTC device according to a predefined UE specific parameter. This method just employs predefined rules, and thus may minimize the specification efforts. In the explicit method 1, the MTC device transmits an explicit message to the network via a non-access layer signaling to indicate its state change. This function may be implemented by defining a new non-access layer signaling or extending the current signaling. In the explicit method 2, a RRC message is used. This method may extend the conventional RRC message such as a measurement report message, or define a new RRC message. If the BS receives such a message, it will transfer the message to the MME.

The second transmitting means 402 is configured to transmit a feature deactivation request. The second transmitting means 402 is different in operation from the first transmitting means 401 only in that the second transmitting means 402 transmits the feature deactivation request instead of the feature activation request, and thus it will not be detailed here.

The receiving means 403 is configured to receive a feature configuration message. If the received feature configuration message indicates permission of feature activation, it will be input into the feature activation means 404 which may activate the feature such that the MTC device may operate in a feature activated state. If the received feature configuration message indicates refusal of feature activation, the feature activation means 404 may keep the MTC device in the feature deactivated state. If the received feature configuration message indicates permission of feature deactivation, it will be input into the feature deactivation means 405 which may deactivate the feature such that the MTC device may operate in a feature deactivated state. Otherwise, if the received feature configuration message indicates refusal of feature deactivation, the feature deactivation means 405 may keep the MTC device in the feature activated state.

In one example, the MTC device is an MTC device with Priority Alarm feature. In this example, the first transmitting means 401 is configured to transmit a Priority Alarm feature activation request. The second transmitting means 402 is configured to transmit a Priority Alarm feature deactivation request. The receiving means 403 is configured to receive a Priority Alarm feature configuration request. The feature activation means 404 is configured to activate the Priority Alarm feature such that the MTC device may operate in a Priority Alarm feature activated state if the received Priority Alarm feature configuration message indicates permission of Priority Alarm feature activation; otherwise, to keep the MTC device in the Priority Alarm feature deactivated state if the received feature configuration message indicates refusal of Priority Alarm feature activation. The feature deactivation means 405 is configured to deactivate the Priority Alarm feature such that the MTC device may operate in a Priority Alarm feature deactivated state if the received Priority Alarm feature configuration message indicates permission of Priority Alarm feature deactivation; otherwise, to keep the MTC device in the Priority Alarm feature activated state if the received feature configuration message indicates refusal of Priority Alarm feature deactivation.

In FIG. 4b, a schematic diagram of a general MTC device 400 with the Extra Low Power Consumption feature activation/deactivation function of the present invention is illustrated. The MTC device 400 includes a first transmitting means 401, a second transmitting means 402, a receiving means 403, a feature activation means 404, a feature deactivation means 405 and a DRX cycle setting means 406.

In particular, when the MTC device 400 needs to enter into an Extra Low Power Consumption feature state, the first transmitting means 401 is triggered to transmit an Extra Low Power Consumption feature activation request. The Extra Low Power Consumption feature activation request may be transmitted in either the implicit method or the explicit methods, depending on the system setting. In the implicit method, the MTC device transmits an Extra Low Power Consumption feature activation request including a predefined UE specific DRX parameter to the network. For example, in case where the UE specific DRX parameter such as the information of 512 subframes is to be transmitted to the MME, the MME may identify that the MTC device needs to enter into the Extra Low Power Consumption state. In the explicit method 1, the first transmitting means 401 transmits an explicit message to the network via a non-access layer message to indicate its state change and requests for activation of the Extra Low Power Consumption feature. In the explicit method 2, the first transmitting means 401 transmits a RRC message to indicate its state change and requests for activation of the Extra Low Power Consumption feature. This method may extend the conventional RRC messages such as the measurement report message or define a new RRC message.

On the other hand, when the MTC device 400 needs to exit from an Extra Low Power Consumption feature state, the second transmitting means 402 is triggered to transmit an Extra Low Power Consumption feature deactivation request. The Extra Low Power Consumption feature deactivation request may be transmitted in either the implicit method or the explicit methods, depending on the system design constraint. In the implicit method, the MTC device transmits an Extra Low Power Consumption feature deactivation request including a predefined UE specific DRX parameter to the network. For example, in case where the UE specific DRX parameter such as the information of 32 subframes is transmitted to the MME, the MME may identify that the MTC device needs to exit from the Extra Low Power Consumption state. In the explicit method 1, the first transmitting means 401 transmits an explicit message to the network via a non-access layer message to indicate its state change and request for deactivation of the Extra Low Power Consumption feature. In the explicit method 2, the first transmitting means 401 transmits a RRC message to indicate its state change and requests for deactivation of the Extra Low Power Consumption feature. This method may extend the conventional RRC messages such as the measurement report message or define a new RRC message.

The receiving means 403 is configured to receive an Extra Low Power Consumption feature configuration message. If the received feature configuration message indicates permission of the Extra Low Power Consumption feature activation, it will be input into the Extra Low Power Consumption feature activation means 404 which may activate the Extra Low Power Consumption feature such that the MTC device may operate in the Extra Low Power Consumption feature activated state. If the received feature configuration message indicates refusal of the Extra Low Power Consumption feature activation, the feature activation means 404 may keep the MTC device in the feature deactivated state. If the received Extra Low Power Consumption feature configuration message indicates permission of the Extra Low Power Consumption feature deactivation, it will be input into the Extra Low Power Consumption feature deactivation means 405 which may deactivate the Extra Low Power Consumption feature such that the MTC device may operate in the Extra Low Power Consumption feature deactivated state. Otherwise, if the received feature configuration message indicates refusal of feature deactivation, the feature deactivation means 405 may keep the MTC device in the feature activated state.

Furthermore, the MTC device 400 includes DRX cycle setting means 406 which is configured to set the UE specific DRX cycle as the actual cycle value for the DRX when the MTC device 400 operates in the Extra Low Power Consumption feature activated state, and to set the smaller of the UE specific DRX cycle and a system default cycle as the actual cycle value for the DRX.

It may be understood that the present invention may be implemented in hardware, software, firmware or the combination thereof. It will be appreciated for those skilled in the art that the present invention may also be embodied in a computer program product embodied on a signal bearing medium for use by any suitable data processing system. The signal bearing medium may be a transmission medium or recordable medium for machine readable information, including magnetic medium, optical medium or other suitable medium. Examples of the recordable medium include disk or floppy disk in a hard disk drive, an optical disc drive for optical discs, magnetic tape and other medium that may be conceived by those skilled in the art. It will be appreciated for those skilled in the art that any communication device with suitably programmed means may implement the method steps of the present invention embodied in the program product.

It may be appreciated from the above that, various embodiments of the present invention may be modified or varied without departing from the scope of the present invention. The description is only illustrative and not for limitation. The scope of the present invention is defined by the claims.

1. A method for feature activation in Machine Type Communication MTC, comprising:
transmitting, by a MTC device, a feature activation request for a feature to a Mobility Management Entity MME;
checking, by the MME, whether the MTC device has subscribed to the feature;
if the MTC device has subscribed to the feature, permitting, by the MME, the feature activation request, and transmitting, by the MME, a feature state updating request to a Home Subscriber Server HSS to update feature state of the MTC device;
transmitting, by the HSS, a feature state updating response to the MME;
transmitting, by the MME, a state change message to a Base Station BS;
performing, by the BS, radio access network optimization, the MTC device then entering into a feature activated state; and
if the MTC device has not subscribed to the feature, transmitting, by the MME, a response message indicating refusal of the activation request, the MTC device remaining in a feature deactivated state.

2. The method of claim 1, wherein if the MTC device has not subscribed to the feature, a subscription request is transmitted from the MME to the HSS, and the HSS inquires a MTC server about whether to perform a feature subscription.

3. The method of claim 1, wherein transmitting, by an MTC device, a feature activation request for a feature to a MME comprises:
transmitting, by the MTC device, the feature activation request to the BS by using a non-access layer signaling, the feature activation request being then transmitted by the BS to the MME; or
transmitting, by the MTC device, the feature activation request to the BS by using a Radio Resource Control (RRC) message, the feature activation request being then transmitted by the BS to the MME.

4. (canceled)

5. The method of claim 1, wherein transmitting, by an MTC device, a feature activation request for a feature to a MME comprises transmitting a predefined parameter to the MME.

6. The method of claim 3, wherein the feature comprises an Extra Low Power Consumption feature, the feature state comprises an Extra Low Power Consumption feature state, and the radio access network optimization comprises Radio Resource Control (RRC) connection reconfiguration; or wherein the feature comprises a Priority Alarm feature, and the feature state comprises a Priority Alarm feature state.

7. (canceled)

8. The method of claim 5, wherein the feature comprises an Extra Low Power Consumption feature, the feature state comprises an Extra Low Power Consumption feature state, the MTC device operates in a Discontinuous Reception (DRX) state when the feature state is the Extra Low Power Consumption feature state, and the predefined parameter is a predefined UE specific DRX cycle.

9. The method of claim 6, wherein after the radio access network optimization, the MTC device operates in a Discontinuous Reception (DRX) state when the feature state is the Extra Low Power Consumption feature state, and DRX cycle is a UE specific DRX cycle.

10. A method for feature deactivation in Machine Type Communication MTC, comprising:
transmitting, by a MTC device, a feature deactivation request for a feature to a Mobility Management Entity (MME);
permitting, by the MME, the feature activation request, and transmitting, by the MME, a feature state updating request to a Home Subscriber Server HSS to update feature state of the MTC device;
transmitting, by the HSS, a feature state updating response to the MME;
transmitting, by the MME, a state change message to a Base Station BS; and
performing, by the BS, radio access network optimization, the MTC device entering into a feature deactivated state.

11. The method of claim 10, wherein transmitting, by an MTC device, a feature deactivation request for a feature to an MME comprises:
transmitting, by the MTC device, the feature deactivation request to the BS by using a non-access layer signaling, the feature deactivation request being then transmitted by the BS to the MME; or transmitting, by the MTC device, the feature deactivation request to the BS by using a Radio Resource Control (RRC) message, the feature deactivation request being then transmitted by the BS to the MME.

12. (canceled)

13. The method of claim 10, wherein transmitting, by an MTC device, a feature deactivation request for a feature to an MME comprises transmitting a predefined parameter to the MME.

14. The method of claim 11, wherein the feature comprises an Extra Low Power Consumption feature, the feature state comprises an Extra Low Power Consumption feature state, and the radio access network optimization comprises Radio Resource Control (RRC) connection reconfiguration; or wherein the feature comprises a Priority Alarm feature, and the feature state comprises a Priority Alarm feature state.

15. (canceled)

16. The method of claim 13, wherein the feature comprises an Extra Low Power Consumption feature, the feature state comprises an Extra Low Power Consumption feature state, the MTC device operates in a Discontinuous Reception (DRX) state when it exits the Extra Low Power Consumption feature state, and the predefined parameter is the smaller value of a predefined UE specific DRX cycle and a system default cycle.

17. The method of claim 14, wherein after the radio access network optimization, the MTC device operates in a Discontinuous Reception (DRX) state when the feature state is the Extra Low Power Consumption feature state, and DRX cycle is the smaller value of a UE specific DRX cycle and a system default cycle.

18. A Machine Type Communication (MTC) device comprising:
first transmitting means configured to transmit a feature activation request;
second transmitting means configured to transmit a feature deactivation request;
receiving means configured to receive a feature configuration message;
feature activation means configured to activate a feature such that the MTC device operates in a feature activated state when the received feature configuration message indicates permission of feature activation; otherwise, to keep the MTC device in a feature deactivated state when the received feature configuration message indicates refusal of feature activation; and
feature deactivation means configured to deactivate a feature such that the MTC device operates in a feature deactivated state when the received feature configuration message indicates permission of feature deactivation; otherwise, to keep the MTC device in a feature activated state when the received feature configuration message indicates refusal of feature deactivation.

19. The MTC device of claim 18, wherein
the first transmitting means is configured to transmit an Extra Low Power Consumption feature activation request;
the second transmitting means is configured to transmit an Extra Low Power Consumption feature deactivation request;
the receiving means is configured to receive an Extra Low Power Consumption feature configuration message;
the feature activation means is configured to activate an Extra Low Power Consumption feature such that the MTC device operates in an Extra Low Power Consumption feature activated state when the received Extra Low Power Consumption feature configuration message indicates permission of Extra Low Power Consumption feature activation; otherwise, to keep the MTC device in an Extra Low Power Consumption feature deactivated state when the received feature configuration message indicates refusal of Extra Low Power Consumption feature activation; and
the feature deactivation means is configured to deactivate an Extra Low Power Consumption feature such that the MTC device operates in an Extra Low Power Consumption feature deactivated state when the received Extra Low Power Consumption feature configuration message indicates permission of Extra Low Power Consumption feature deactivation; otherwise, to keep the MTC device in an Extra Low Power Consumption feature activated state when the received Extra Low Power Consumption feature configuration message indicates refusal of Extra Low Power Consumption feature deactivation,
wherein the MTC device further comprises Discontinuous Reception (DR)( )cycle setting means configured to set a UE specific DRX cycle as an actual cycle value for the DRX when the MTC device operates in the Extra Low Power Consumption feature activated state, and to set the smaller value of the UE specific DRX cycle and a system default cycle as the actual cycle value for the DRX when the MTC device operates in the Extra Low Power Consumption feature deactivated state; or
the first transmitting means is configured to transmit a Priority Alarm feature activation request;
the second transmitting means is configured to transmit a Priority Alarm feature deactivation request;
the receiving means is configured to receive a Priority Alarm feature configuration message;
the feature activation means is configured to activate a Priority Alarm feature such that the MTC device operates in a Priority Alarm feature activated state when the received Priority Alarm feature configuration message indicates permission of Priority Alarm feature activation; otherwise, to keep the MTC device in a Priority Alarm feature deactivated state when the received Priority Alarm feature configuration message indicates refusal of Priority Alarm feature activation; and
the feature deactivation means is configured to deactivate a Priority Alarm feature such that the MTC device operates in a Priority Alarm feature deactivated state when the received Priority Alarm feature configuration message indicates permission of Priority Alarm feature deactivation; otherwise, to keep the MTC device in a Priority Alarm feature activated state when the received Priority Alarm feature configuration message indicates refusal of Priority Alarm feature deactivation.

20. (canceled)
